(19) United States
(12) Patent Application Publication
(10) Pub. No.: US 2014/0040075 A1
(43) Pub. Date: Feb. 6, 2014

(54) SYSTEM AND METHOD OF SELECTION AND ORGANIZATION OF CUSTOMER ORDERS IN PREPARATION FOR DISTRIBUTION OPERATIONS ORDER FULFILLMENT

(71) Applicant: Vargo Adaptive Software LLC, Hilliard, OH (US)

(72) Inventors: Daniel C. Perry, Buda, TX (US); Gary Yee, Berkeley, CA (US); Carlos N. Ysasi, Hilliard, OH (US); Vith Pinthapataya, Castro Valley, CA (US); Bart J. Cera, Delaware, OH (US); William Kelly Shutt, Austin, TX (US)

(73) Assignee: VARGO Adaptive Software LLC, Hilliard, OH (US)

(21) Appl. No.: 13/958,263

(22) Filed: Aug. 2, 2013

Related U.S. Application Data
(60) Provisional application No. 61/679,507, filed on Aug. 3, 2012.

(51) Int. Cl. G06Q 30/06

(52) U.S. Cl. CPC G06Q 30/0635
USPC 705/26.81

(57) ABSTRACT

A system may receive orders from disparate sources, each order specifying at least one item located in a physical storage area divided into subareas. The orders may be prioritized for desired processing sequence. The system may determine, beginning with high priority orders specifying at least two items for each order, a virtual order footprint that represents all of the subareas corresponding to the items in the order and form a plurality of virtual potential pick batches, each virtual potential pick batch comprising orders in a unique virtual order footprint. When a configurable limit is reached, the number of orders in each virtual potential pick batch is determined. The order counts are a factor in determining which of the virtual potential pick batches are to be released for processing by available work resources. All other non-selected virtual potential pick batches are deconstructed awaiting the future availability of work resources.

### CROSS-REFERENCE TO RELATED APPLICATION(S)

This is a conversion of and claims a benefit of priority from U.S. Provisional Application No. 61/679,507, filed Aug. 3, 2012, entitled “SYSTEM AND METHOD OF SELECTION AND ORGANIZATION OF CUSTOMER ORDERS IN PREPARATION FOR DISTRIBUTION OPERATIONS ORDER FULFILLMENT,” which is hereby incorporated herein for all purposes.

### TECHNICAL FIELD

This disclosure relates generally to order fulfillment operations that require physical gathering of products at a facility before the products can aggregated by the order to be delivered. More particularly, embodiments disclosed herein relate to a new system and method that can intelligently select and organize incoming orders for highly efficient fulfillment operations.

### BACKGROUND

Physical distribution operations responsible for delivering products relate to those operations that have a significant number of orders with few but more than one item in each outbound shipment package. These types of orders typify ecommerce direct to consumer operations. Today, direct to consumer (DTC) or eCommerce (eCom) operations that are required to deliver substantial volume of “multi-unit orders” or “multies” (i.e., orders with more than 1 item per shipment package) yet few items per order continue to face challenges that tax conventional distribution processes that have evolved from high unit volume orders found in retail distribution. These challenges include: very large variations in daily workload, a more or less constant arrival of new orders, staffing constraints, shrunken order delivery requirements, ever growing variety of offered products, small order item counts, limited predictability of immediate inbound orders, and the control of shipment costs.

Numerous approaches have been designed to reduce the expense of fulfilling these orders and are used today, and the specific solution chosen is normally chosen based on the required expected facility volume.

Low volume approaches for DTC or eCom fulfillment involve some form of “discrete order picking, packing and shipping” in which a limited number of orders are processed to completion by the accumulation of all order items. Once all order items are collected together, the order is ready for packing and shipping. Some solutions may automate the collection of order items through robots or other means.

Higher volume approaches involve simultaneous gathering of items for many orders into a batch. Once the “batch” of items is gathered the items are sorted into individual orders. The sortation process itself can be either manual or with limited automation or some combination of both. Once an order has all the items collected and sorted completing that order, that order is ready for packing and shipping.

For very high volume approaches, the use of automated “item sortation” equipment (“sorter”) allows items for large batches of orders to be gathered together. The gathering process can be done either manually or through some automated collection equipment (e.g., a “goods-to-man” system). The collected items are then delivered to the sorter where the collected items may be “inducted” onto the sorter. The sorter identifies the items and then sorts them into orders. Once all the items for an order are collected together, identified, and sorted, the order is ready for packing and shipping.

### SUMMARY OF THE DISCLOSURE

Order fulfillment operation requires the flow of a business's product to different areas before it is finally shipped to customers. Order fulfillment processes need to meet the highest level of accuracy and orders need to be shipped on a very tight schedule. Most current operations are not capable of growing or scaling their capacities while maintaining work efficiency and the required delivery timeframe. A system that allows a business to continue to grow into the future needs to be flexible, dynamic, and scalable. Embodiments disclosed herein utilize a system in which specific operational rules are created as necessary to optimize the entire controlled operation. Embodiments described herein may be directed to systems and methods for managing a continuous workflow for buffering, managing, controlling, synchronizing and balancing work in distribution operations such that work resources (workers and equipment) are most fully utilized maximizing both efficiency and system capacity. Embodiments can leverage the characteristics of eCommerce or direct-to-consumer order profiles coupled with, more or less constant, flow of new orders to create a significantly more efficient operation. Embodiments are directed to how to optimize the selection of orders for processing that facilitate the efficient processing of such orders while meeting delivery requirements. The order profile characteristics of eCommerce orders can include a substantial volume of single unit orders and the decreasing volume of orders for subsequent order unit counts. For example: single unit order may comprise 30% of the overall order volume, while 2 unit orders comprise just 25% of the orders and 3 unit orders comprise 18% of the orders and so on.

Embodiments disclosed herein may be directed to distribution functions including order prioritization, order selection, picking (gathering of items), and consolidation of order items. Embodiments may use “data” or logical buffering to the extent possible to ensure the timely delivery of the package for shipping departure. Embodiments may identify means to select orders that have “picking synergy” or “order synergy” to allow the efficient picking of the items for those orders. Embodiments can minimize the duration of the collection of items for individual orders. This, in turn, can reduce the number of physical queues of in-process work (work-in-process) for order item consolidation. The reduction of the duration of the consolidation of items for individual orders allows the consolidation space to be re-used more frequently increasing the production capacity of the operation. The physical labor (workforce) is involved with only the gathering of order items (picking) and the combining or consolidation of order items to form complete orders. Embodiments can minimize the picking and consolidation efforts, while allowing those functions to be scaled to meet the required shifts in daily order volume.

One key to meeting highly variable production is to have a highly scalable yet efficient fulfillment process. Scalability refers to the ability to have resources, data processing capacity, workers, and work aids (e.g., totes, stations, carts, etc.) to meet the varying work demands. The economic aspects of scalability may include providing a process that will yield efficient processing at both peak and normal workloads and that is able to pay for the fixed resources using only normal daily or average workloads. An object of the invention is therefore directed to providing an efficient fulfillment process scalable to accommodate variable workloads, including peak and normal workloads.

This object can be achieved in a method that includes receiving, by a system embodied on a non-transitory computer readable medium, orders from disparate sources communicatively connected to the system over a network. Each order may specify at least one item located in a physical storage area that has been divided into two or more subareas. In some embodiments, the orders may be prioritized in a desired processing sequence. Work resources necessary to process the orders may become available from time to time.

In some embodiments, the method may further include determining, for each order received and beginning with high priority orders specifying at least two items, a virtual order footprint that represents all of the subareas storing physical items corresponding to the items listed in the order and forming a plurality of virtual potential pick batches. Each virtual potential pick batch may include a set of orders in a unique virtual order footprint.

In some embodiments, the method may further include, determining an order count for each virtual potential pick batch of the plurality of virtual potential pick batches when a configurable limit is reached and, based at least in part on the order counts in the plurality of virtual potential pick batches, selecting which of the plurality of virtual potential pick batches are to be released for processing by work resources that have become available. In some embodiments, the selected virtual potential pick batches released by the system for processing may be communicated via a printer, an audio means, a wireless means, or a combination thereof. In some embodiments, the rest of the virtual potential pick batches that are not selected for processing at this time are deconstructed awaiting future availability of work resources.

In some embodiments, the configurable limit may be defined with respect to time, a number of orders, or a combination thereof. In some embodiments, to achieve a higher pick density and/or order synergy, the configurable limit may be configured to override the processing sequence in which the orders are prioritized.

In some embodiments, the method can be implemented in a system having at least one processor and at least one non-transitory computer-readable medium storing instructions translatable by the at least one processor to cause the system to perform the method. In some embodiments, the method can be implemented in a computer program product having at least one non-transitory computer-readable medium storing instructions translatable by at least one processor to cause a system to perform the method.

Other objects and advantages of the invention will become apparent to one skilled in the art upon reading and understanding the detailed description of the example embodiments described herein with reference to the following drawings.

### BRIEF DESCRIPTION OF THE DRAWINGS

A more complete understanding of the invention and the advantages thereof may be acquired by referring to the following description, taken in conjunction with the accompanying drawings in which like reference numbers indicate like features, and wherein:

FIG. 1 depicts a diagrammatic representation of an example network architecture illustrating how orders are received from disparate sources by one embodiment of a system over network connections;

FIG. 2 depicts a diagrammatic representation of an example system implementing one embodiment of a method for processing orders received from disparate sources;

FIG. 3A depicts a diagrammatic representation of an example physical storage area;

FIG. 3B depicts a diagrammatic representation of an example physical storage area of FIG. 3A divided into subareas according to one embodiment;

FIGS. 4A and 4B depict diagrammatic representations of an example physical storage area divided into different sets of subareas;

FIG. 5 depicts a diagrammatic representation of an example of grouping storage areas into subareas to represent a total physical storage area according to one embodiment;

FIG. 6 depicts a diagrammatic representation of an example system architecture in which embodiments disclosed herein may be implemented; and

FIG. 7 depicts a flow diagram illustrating an example method according to one embodiment.

### DETAILED DESCRIPTION

The invention and various features and advantageous details thereof will now be described with reference to the exemplary, and therefore non-limiting, embodiments that are illustrated in the accompanying drawings. Descriptions of known programming techniques, computer software and hardware, and the like may be omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein provide a solution that is a highly scalable, requires low capital expenditure, and includes a highly efficient process that is driven by the optimization and control of the workflow. The solution need not be embodied in any particular equipment or physical configuration, rather a method that is applicable to a wide variety of physical implementations. More specifically, embodiments take advantage of a number of attributes of the fulfillment requirements of direct-to-consumer orders to more efficiently deliver those orders. One of the attributes of direct-to-consumer orders is that they have a limited number of items for each order. A second attribute is that new orders are normally arriving continuously. The third attribute is that most orders will actually leave the fulfillment facility at a set of specific times during the day—processing them earlier than that time will not yield any earlier delivery time to the customer. Embodiments disclosed herein may be useful for improving the efficiency of order fulfillment processes, particularly in direct-to-consumer or eCom operations. Specifically, embodiments can apply “just-in-time” methodologies to provide more economical and scalable volume distribution operations to meet the challenges of the DTC or eCom facilities.

Before describing the features and associated advantages of embodiments, it may be helpful to understand certain terms used in this disclosure.

As used herein, an order generally refers to a request for products or other physical items. Thus, an order may include a request for a good, a free catalog, a kit, or the like, and may request a single item or multiple items. Embodiments disclosed herein may be particularly useful in processing orders each containing two or more distinct items.

As used herein, an information pool may refer to a data logging mechanism containing a plurality of orders before the orders have been analyzed or assigned to be fulfilled. An order may be received and may have a time/date stamp or some other information associated therewith while in the information pool and/or assigned a priority status and stored. Thus, an information pool may be a normal order pool containing non-prioritized orders or may be a pool of orders that have been designated as priority orders.

A virtual potential pick batch may refer to a group of orders that has been taken out of an information pool and is in the process of being analyzed, organized, picked, consolidated, packed or shipped as part of the fulfillment process. A continuous batch refers to a batch that more or less continually replaces completed orders within the batch with new orders maintaining a batch size. A continuous batch does not necessarily have an end.

A total physical storage area may refer to an entire warehouse or other physical facility that stores physical items for fulfilling the orders. The total physical storage area may be a single room or building, or may include multiple buildings in different areas.

A subarea may refer to a portion of a total physical storage area. The size and number of subareas may change depending on different factors, and a subarea may be a portion of a room or building, or may be a separate room or building, or some combination. A total physical storage area is represented by the sum of all the subareas associated therewith.

A virtual order footprint may refer to a representation of an order footprint which may comprise a set of subareas. If an item is located in a subarea, a product identifier (ID) or the like will be associated with a virtual order footprint corresponding to that subarea. If the size/extent/definition/configuration of and/or items in the subarea changes, the virtual order footprint may change as well.

A pack group may refer to a group of orders in a virtual potential pick batch that corresponds to a particular virtual order footprint or a similar virtual order footprint. Preferably, each pack group in a virtual potential pick batch corresponds to a single virtual order footprint, and the virtual potential pick batch comprises all the pack groups and therefore all the items for the orders in the group.

A priority sequence refers to a general listing of orders. The priority position or setting of any order within the priority sequence may be based in part on when the order was received, a shipping deadline for that order, a customer number for that order, or some other criteria. The position of any order within the priority sequence (referred to herein as “priority setting”) may be changed at any time. In some embodiments, the priority setting may be violated or overridden (for instance, per a configurable limit, explained below) as needed to achieve higher efficiency, pick density, order synergy, etc.

A resource may refer to a person or equipment useful for picking items for an order. Examples of a resource may include a person or automated robot for picking an item, a scanner gun for entering a product ID to allow a tracking system to know that the item has been picked, a tote for holding the item, a forklift for carrying a heavy tote or item, and so on.

A tote may refer to a hand-held container for carrying items, but may also refer generically to a pallet, a cart, or any container that can hold all the items picked when gathering items. A tote may have wheels, may be motorized, may be suspended from a cable or otherwise configured to allow a worker to easily proceed through a physical storage area to pick items. In some embodiments, each tote may have a license plate, a bar code, or some other means for uniquely identifying that tote, which enables the tote to be tracked and the contents of the tote to be associated with specific orders.

A configurable limit may refer to a time limit, a number of orders, a number of available resources, or the some other variable. For example, as described below, embodiments may receive and process orders throughout the day. Early in the day, a configurable limit may specify a time for performing this process. As a shipping deadline nears, this time limit may change to fewer hours or even less than an hour. In some embodiments, a configurable limit may specify how many orders can be processed, ranging from a few to several thousand.

A functional overview of order processing for a DTC or eCom operation may also be helpful to aid in the understanding of embodiments disclosed herein, and may indicate where and how “buffering” interacts with the functions of a distribution process. In some embodiments, buffering is where the invention takes advantage of opportunities improvement. The primary “work” for a DTC system represents orders that must be fulfilled and shipped to customers. The distribution center may have thousands of items for shipping to the customers. To streamline the order filling process, when an order is received into the DTC system, the system logically buffers the orders into an information pool until there are sufficient orders to ensure efficient use of available resources. The orders can be buffered until enough orders are pooled together for efficient workflow or there is a deadline such that the order(s) have to be filled even if it means an inefficient workflow. When necessary to create a new batch or to add orders to an existing continuous batch, the system selects orders with identical or similar virtual order footprints, identifies product IDs or other codes associated with the items requested, and assigns the orders to various pack groups within the batch.

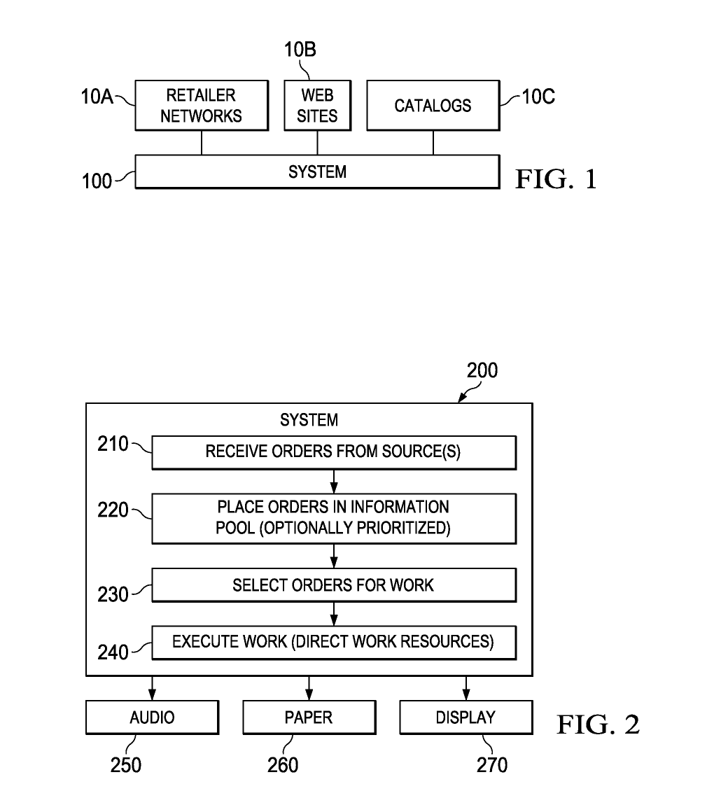

Turning now to the figures, FIG. 1 depicts a diagram illustrating one embodiment of an example network architecture, illustrating how a distribution operation system may operate to receive orders from disparate sources. In this example, disparate sources may include retailer networks 10A, web sites 10B, and catalogs 10C. System 100 may be independently owned and operated from disparate sources. Orders may be received by system 100 from a computer communicatively connected to system 100 over a network via various communications means including, but are not limited to, e-mail, phone, fax, mail, manual entry, or some other method.

FIG. 2 depicts a diagrammatic representation of an example system implementing one embodiment of a method for processing orders received from disparate sources. System 200 may implement one embodiment of a method comprising receiving orders from sources (e.g., disparate sources 10A-10C shown in FIG. 1) (step 210). In one embodiment, a connected source computer may deliver new orders more or less continually based on a preference set by a host system associated with the source computer.

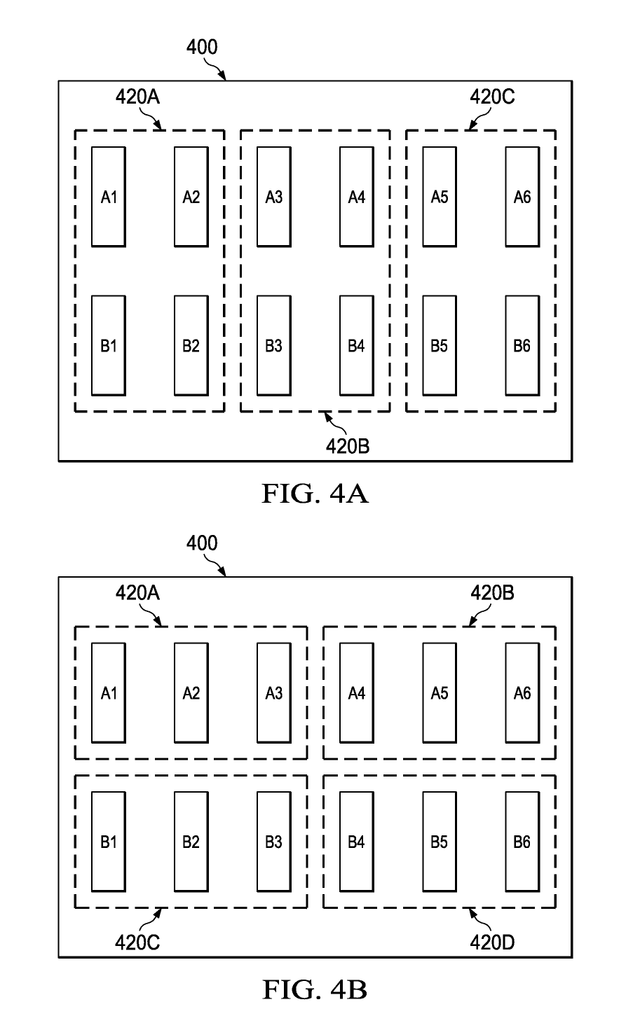

In some embodiments, system 200 may place received orders in an information pool and optionally prioritized (step 220). In some embodiments, system 200 may store the orders in a repository (e.g., database 480 shown in FIG. 4). In some embodiments, the information pool may represent a “work backlog.” In some embodiments, system 200 may buffer the orders according to the time an order was received by the system and may assign a time/date stamp, or system 200 may determine that a received order should be given a higher priority and may associate other data that designates the order as having a selected priority. For example, a customer may specify delivery requirements or shipment methods such that an order is designated a priority order, or the distribution center may further add prioritization criteria (e.g., preferred customer, special offer, etc.) to the individual order. These attributes coupled with the time the order was actually received may be used to identify the relative importance of orders received. If an order is determined to be a higher priority, the order may be tagged or otherwise identified as being a priority order and pooled with other priority orders for processing according to a priority sequence. In some cases, as discussed below, a priority order may need to be activated for immediate fulfillment regardless of its position in a priority sequence. The host systems which sent the orders need not organize the orders.

Work (order processing) is generally not performed on orders in the information pool. Rather, in some embodiments, certain orders may be selected and moved out of the information pool and placed in a virtual potential pick batch (referred to hereinafter as “pick batch” or “batch”) where the orders are “worked” (step 230). Work resources may become available from time to time. In some embodiments, orders may be moved out of the information pool and placed into a pick batch only when work resources are immediately available to perform the work. When that occurs, system 200 may execute work by releasing certain selected pick batches for processing (step 240) and communicate same to available work resources via audio means 250 (e.g., by sending an automated message, a bell, or some other established means), paper means 260 (e.g., by printing a pick list with personnel name(s) and/or ID(s) printed thereon), and/or display means 270 (e.g., by sending a message or pick list to a wireless unit associated with a personnel).

The movement of an order from the information pool and into a pick batch may be referred to as order “activation.” The system may continually focus on completing already active orders prior to activating any new orders. Further, a pick batch may be kept to the minimum possible size such that the time to complete the active work is as small as possible. This way, new pending work may be activated as quickly as possible. There may be two or more separate sets of rules that normally govern the selection of what new work (which order or orders) is activated. One set of rules may govern the relative “priority” of the work (orders) in the information pool. The highest priority orders are continually being moved to the “top” of the pool. Thus, based on prioritization rules, newly added orders may be activated prior to older existing orders in the information pool. A second rule set governing the selection of the order or orders to activate may be referred to as “order pool mining.”

A purpose of order pool mining is to select an order or orders to activate from among the highest priority orders, but also allow orders to be activated that will optimize the efficiency of the work. In some cases, the latter may involve violating a predetermined priority sequence to achieve order synergy. For example, in one embodiment, orders with similar virtual order footprints may be selected within a configurable limit with respect to time and/or a number of orders regardless of their respective priority position in the priority sequence. That is, in order to accomplish the efficient “mining” of synergistic orders, the selection or combining of new orders into a new batch can be held up until an efficient batch for both picking, confirmation, and packing can be created. There are configurable limits and rules that determine the amount of time. For example, the limit of how long orders will be held awaiting arrival of synergistic orders may be a function of the availability of existing batches to keep the available work resources busy or how far down in the information pool to look for highly synergistic orders before reverting to less synergistic orders. Thus, if there is already available and necessary work for the available pick resources, there is no need to create another batch since waiting longer will yield a batch with a higher pick density or more synergistic orders. In other words, the system does not indiscriminately create new batches and has the intelligence to determine when a new batch should be created to achieve high pick density/order synergy, violating a priority sequence if and when necessary. Other factors that may impact how long orders are held up may include the oldest order age (in the batch category), the total held order (work) backlog, a scheduled workforce availability, a work rate and a required completion time (departure time).

Embodiments may use these rule sets to ensure that work proceeds as efficiently as possible and the most important orders are completed before the completion of lesser importance orders. An example of how this can benefit a business can be that non-time critical work (which has a due date that is sometime in the future) can act as “filler” work where work resources are always directed to complete the time sensitive work first.

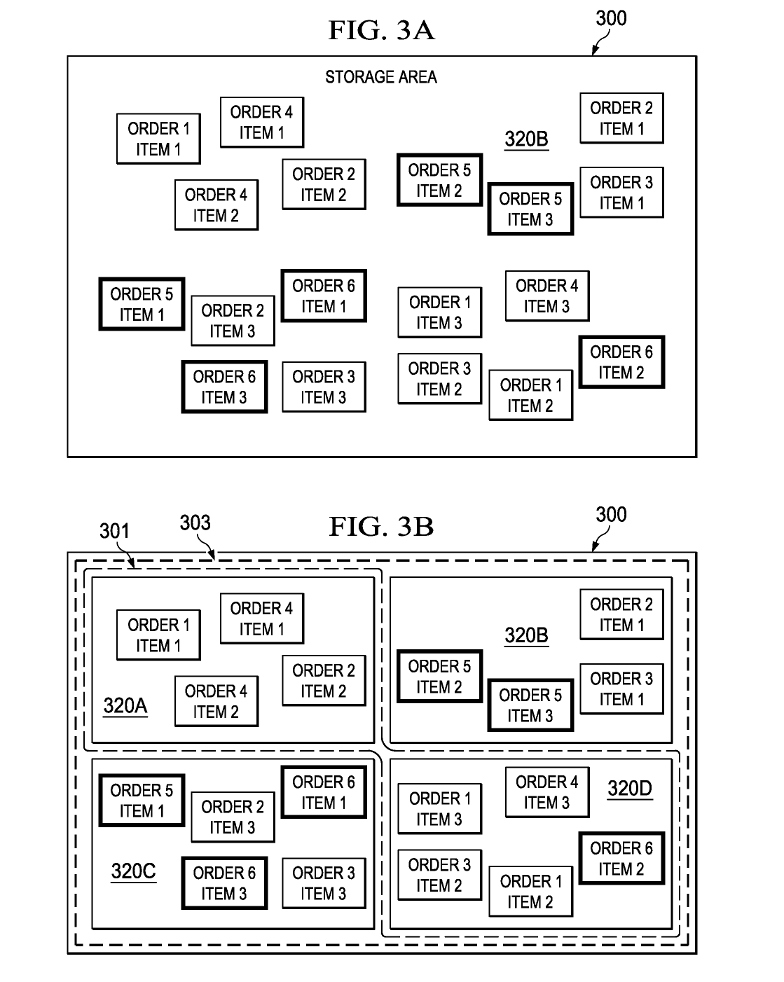

To aid in better understanding of pick density/order synergy, a description of how pack groups are formed may be helpful. In some embodiments, the most scalable method of item gathering may involve using workers to pick items, and a key factor to efficient manual item gathering (item picking) is to have the highest possible “pick density,” which results in the shortest travel paths between items to be picked. In retail or conventional distribution operations, high pick density is normally easy to achieve as order item counts and volume are high. However, in DTC operations where order item counts are very low but greater than one, pick item density for a single order is very low. To illustrate, FIG. 3A depicts a diagrammatic representation of an example physical storage area for a DTC distribution operation. A worker trying to fill orders #1-#6 individually must travel the entire storage area 300 and yet each order only has a few items, resulting in a very low pick density per order. If a total physical storage area is small, the travel distance needed to fill each order may be manageable for a brief period. However, if the total physical storage area is large, the travel distance becomes more significant and there may be delays waiting for a worker to gather the items for an order.

Solving the problems associated with low pick density has been the source of various approaches to improving distribution operations. As mentioned above, in some prior approaches, in order to collect all the items for order #1 a worker must travel to each of the locations containing the items for the order. These long travel paths result in a lot of walking or travelling by the worker and also result in delays as the operation center has to wait for the worker to bring back the items for a first order before proceeding to a second order.

Another approach has been to simply hire more workers or add more equipment to ensure all the orders during peak times are processed in a timely manner. However, those skilled in the art will appreciate that the additional overhead of more workers and equipment may be detrimental to the operation. In fact, providing fixed mechanical or automated resources necessary handle the peak work requirements may yield an average utilization of those resources of less than 20%, and the return on investment (ROI) of such a system may be 5 times longer at the 20% utilization. Those skilled in the art will appreciate that this statement can apply to all aspects of process automation.

Another approach to overcoming low pick density attempts to group items by their popularity, creating areas with popular or fast moving items and areas of less popular or slow moving items. The concept is that a number of orders may be filled from a smaller storage area. However, in practice, for multi-item orders, the probability of all order items for a single order “being popular” is not operationally significant.

Yet another approach to overcoming low pick density is to have workers pick items for multiple orders at the same time. One offshoot of this methodology is to have the worker transport several order packages to all the locations containing items for the several transported orders. This approach is generally targeted for use by businesses in which items are small and light such that workers can carry sufficient orders to make the pick process have adequate productivity. The idea behind this method is that the picking and consolidation of order items are done in the same operation. Drawbacks are that items may be easily placed with the wrong order and the physical space for holding an order is normally sufficient to hold a large order while that space is occupied only with the average size order.

The consolidation of orders items refers to collecting like order group items together and then taking the individual items and combining them with the other items needed to complete the order. The packing of orders refers to the placement of all items for an order in a shipment package including all the necessary material or value added services required for the customer. This activity normally ends with a shipping label being attached on the package. Once orders are packed they are delivered to the shipping system. Here, the packages may be held as completed work by the distribution center until the actual shipping departure. Packages may be sorted prior to shipping to improve delivery to the customer. Once the package is actually departed from the distribution operation the fulfillment operation is complete.

A second offshoot of the gathering of items for multiple orders is to gather the items—mixing order items from a first order with items from other orders—and then the entire batch of items being sorted out, consolidating items into their respective individual orders. This approach reduces the error in keeping items with the correct order (assuming the consolidation process is robust) and it allows larger order batches as the space for picked items is shared. Thus, the average space needed for any batch of items may be nearer to the overall average space needed. A drawback to this approach lies in the fact that while there can be great improvement by having a large pick batch size, the size of the batch is a function of the ability of a downstream consolidation operation to sort out the items into individual orders. The drawbacks to this approach are more apparent when there are more items per order. Namely, an order that is being filled (but not yet completely filled) is referred to as a work-in-progress. If there are only two items and the first item has been picked, the order can only be completed once the second item arrives and, until then, the order is a work-in-progress and takes up space, either in a consolidation area or in a checkout station. If the order has several items and each item is in a different part of the warehouse, the order might not be filled for quite some time, and it takes up space in the consolidation area until all items are picked. Thus, increasing the batch size does not necessarily increase the efficiency of the order fulfillment process. This applies to both single sort operations and operations having multiple layers of sorting.

One reason that specific approaches are chosen to handle some given volume is due to the expense of the automated equipment needed to accomplish the work and the volume of the work that is required to make that solution pay for itself over some less automated processes. The cost of the items compared to the cost of distributing the items is also a significant factor. For very expensive items, the distribution cost may be insignificant; however, as the cost of an item decreases, the distribution cost increases proportionally and can drive the distribution approach.

For example, consider the magnitude of work being performed by a typical DTC operation over the course of a single year. The variation in daily work receipts (by week) for a single year may involve a large variation for the number of orders, the number of “singles” (orders having only a single item), and the number of units (which correspond to the number of orders). The variation for orders having a single item may be relatively small, and it may be relatively easy to optimize resources to handle the peaks without incurring excessive overhead during the lows. However, for orders having multiple items, there can be a significant variation, with sharper and higher spikes for some weeks more than others. In these cases, the distribution system typically runs either the risk of not having enough resources to fulfill all the orders during the peak times—and miss shipping deadlines and incur negative customer comments or missed business opportunities—or have enough resources to handle the orders during the peak times but incur excessive overhead during the slow times.

All of the existing approaches must deal with these extreme variations in work. Highly automated systems designed to handle the peak volumes must sit mostly idle for the largest part of the production year. The variation of daily work compared to the average work presents DTC operations with the challenge of investment of expensive automated systems that achieve the best productivity able to meet the demands of the entire year verses less automated and less productive systems to meet that demand. To meet the demand for the peaks part of the year, the system must pay for itself with less than 20% of the peak volume.

Embodiments of an intelligent batch picking solution disclosed herein can overcome the problems of low pick density and extreme variations in order volumes. One key is to minimize the non-productive travel distance and associated time between productive pickings. Another is to form an optimal pack group that would result in the highest pick density for a batch. Embodiments may accomplish this and other goals by selecting orders to form batches that have item area synergies. As new orders are continually arriving, they may be joined with existing orders to form a new pack group, or they may be held awaiting future opportunities to form more optimal pack groups. It is only necessary to complete orders before the required shipment departure, so waiting to create an efficient pack group does not affect the actual production. Furthermore, a new pack group can be created only when a pick worker or other resource (e.g., a tote, scanner, RFID device, etc.) becomes available. By delaying the creation of optimal pack groups as long as possible to provide the most optimized pack group to available workers, embodiments allow arriving orders to assimilate into less optimal pack groups to achieve higher pick density while accommodating variations in order volumes.

To further understand how an optimal pack group may be created, a comparison of FIGS. 3A and 3B may be helpful. FIG. 3A depicts total physical storage area 300 without any division into subareas. As described above, to collect all the items for an order (e.g., order #1), a worker must travel to each of the locations containing items for the order. In contrast, FIG. 3B depicts total physical storage area 300 virtually divided into subareas 320A, 320B, 320C, and 320D. Notice that orders #1 and #4 have items corresponding to subareas 320A and 320D only. Combining those orders into the same pack group can therefore reduce the amount of space (and thus distance) holding the items by one half. Once the items from subareas 320A and 320D are picked and the orders consolidated, two orders will be completed and ready for packing and shipping. In contrast, combining orders #1 and #2 would require subareas 320A, 320B, 320C, and 320D to be covered to fill those orders and is therefore not as synergistic. In other words, a pick batch (represented by virtual order footprint 301 in FIG. 3B) including only orders #1 and #4 in subareas 320A and 320D would have a higher pick density than a pick batch (represented by virtual order footprint 303 in FIG. 3B) with orders #1 and #2 in subareas 320A, 320B, 320C, and 320D. Accordingly, the system may assign a first pack group to a first resource for subarea 320A and assign a second pack group to a second resource for subarea 320D, resulting in two orders being filled without either order being a work-in-progress for very long. Again, contrastingly, fulfilling orders #1 and #2 would require four resources to pick items from all four subareas 320A, 320B, 320C, and 320D or the orders would be works-in-progress while the first resource and second resource go pick items from all four subareas 320A, 320B, 320C, and 320D.

One advantage of embodiments may be the ability to pool (buffer) orders #1-#3, wait for the arrival of order #4 before order #1 was processed, and combine those orders to create an efficient pack group, thereby ensuring that the pick density for each batch is as high as possible. There may not be an opportunity to form a totally efficient pack group. However, a decision to form a less productive pack group can be made, for instance, when order #1 was in jeopardy of missing the shipment departure and/or when there was work resource (e.g., a worker) capable of performing the work.

Those skilled in the art will appreciate that a total physical storage area may be divided into subareas in various ways and not limited to what is shown and described herein. For example, the same physical storage area may be divided into different sets of subareas. This is illustrated in FIG. 4A and FIG. 4B which depicts physical storage area 400 having storage units A1-A6 and B1-B6. These storage units can be racks, shelving units, or any structure configured to hold physical items for order fulfillment. For the sake of convenience and not of limitation, such storage units are referred to hereinafter as “racks.” In FIG. 4A, physical storage area 400 is divided into subareas 420A, 420B, and 420C. However, in FIG. 4B, physical storage area 400 is divided into subareas 420A, 420B, 420C, and 420D. As described above, a pick batch may involve one or more orders having items in one or more of such subareas.

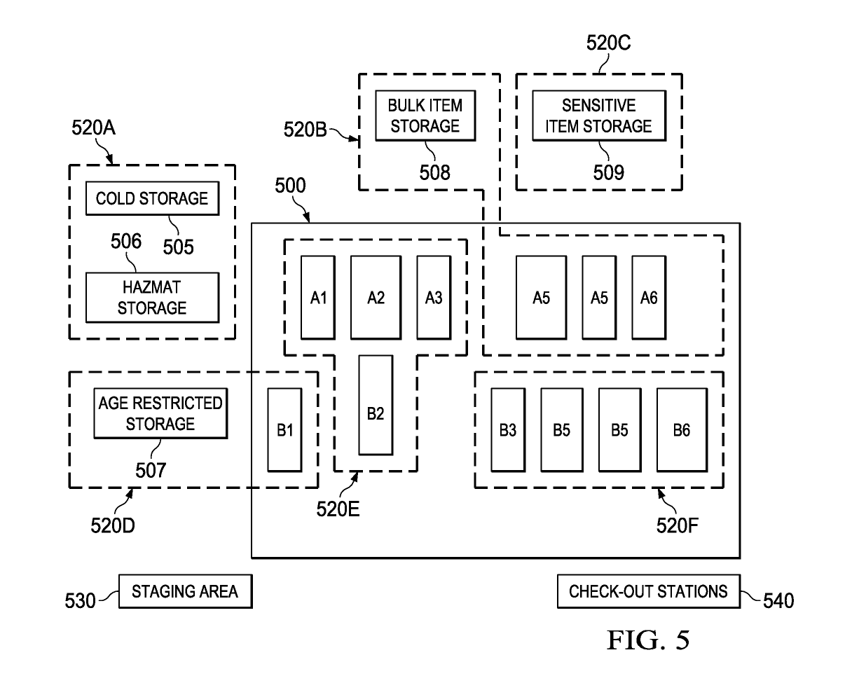

How a physical storage area is divided may depend on one or more criteria associated with physical items stored in the physical storage area. Example criteria may include the location of the physical items in the physical storage area, the number of physical items, the sensitivity/sensitivities of the physical items, special handling instructions concerning the physical item(s), the size(s) of the physical items, priority or priorities associated with the physical items, and so on. In the non-limiting examples of FIGS. 3B, 4A, and 4B, the subareas in a physical storage area are diagrammatically represented roughly equal in size. However, this need not be the case. An example illustrating a more complex division of a physical storage area is shown in FIG. 5.

FIG. 5 depicts a facility having floor 500 with racks A1-A6 and B1-B6, cold storage 505, hazardous material (“hazmat”) storage 506, age-restricted area 507 (such as non-hazardous paint, etc.), bulk item storage 508, and sensitive item storage 509. Rather than defining each of them as a subarea, they can be logically grouped into subareas 502A, 502B, 520C, 520D, 502E, and 520F which, as illustrated in FIG. 5, can have varying sizes, shapes, and configurations.

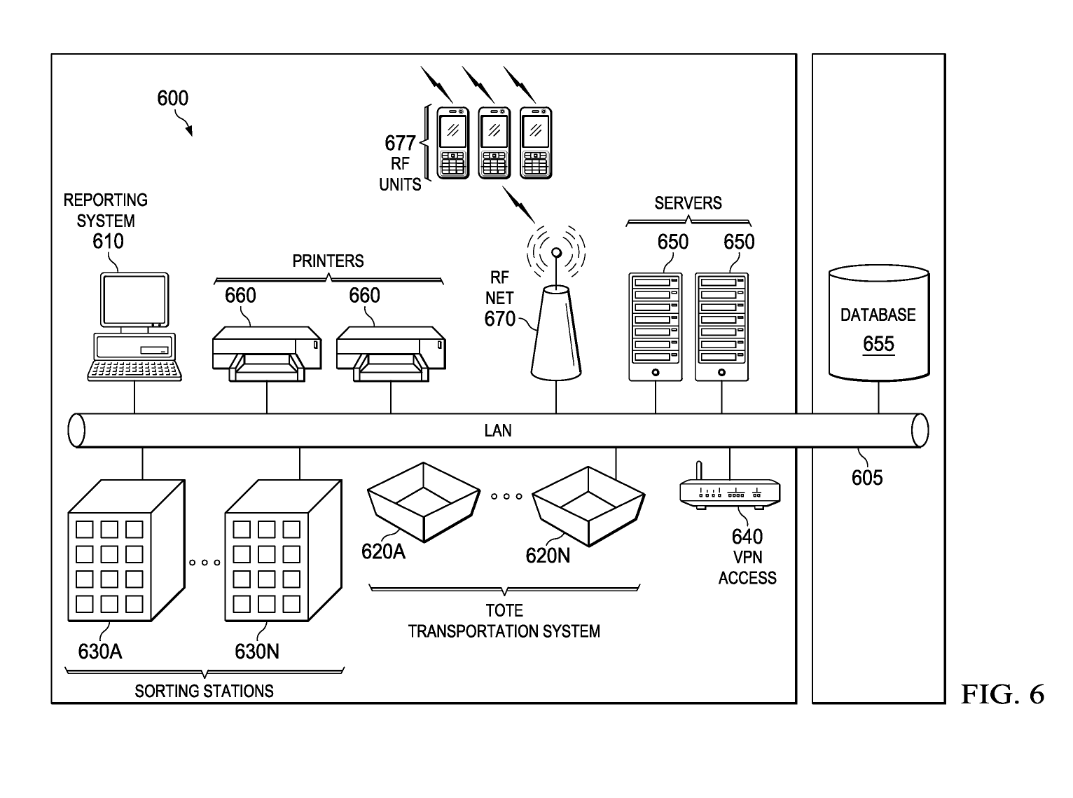

To further highlight novel advantages of the invention, suppose a facility can be divided into four areas: A, B, C, and D, each storing various products or items. Suppose orders #1, #2, #3, and #4 have been received by a continuous order fulfillment system implementing an embodiment disclosed herein (e.g., system 600 shown in FIG. 6) and are selected for activation from an information pool to form a batch. Order #1 may have 10 items with 2 in Area A and 8 in Area B. Order #2 may have 14 items with 4 in Area A, 5 in Area B, and 9 in Area C. Order #3 may have 5 items with 2 in Area C and 3 in Area D. Order #4 may have 11 items with 8 in Area A and 3 in Area B. In this case, the system will group order #1 and order #4 and create a pack group (in some embodiments, this pack group may be part of a virtual potential pick batch) to get 10 items from Area A and 11 items from Area B (in some embodiments, such areas may be represented in the system as a unique virtual order footprint). If totes are used, this only requires two totes (one for Area A and one for Area B) to hold and process the items for order #1 and order #4. A picker only has to make one trip to Area A and Area B to pick up items to fulfill order #1 and order #4. All items picked in this trip are processed and there are no partially filled orders (i.e., no work-in-process).

Notice that in this example, although order #2 also has 4 items in Area A and 5 items in Area B, it is not grouped with order #1 and order #4. This is because order #2 is not a perfect match—it contains 9 items in Area C. If orders #1, #2, and #4 are combined in a pack group, the number of totes required is the same as above; however, after order #1 and order #4 are processed, 4 items will be left in the tote for Area A and 5 items will be left in the tote for Area B. Since order #2 is still missing 9 items from Area C, it cannot be completed at this time and thus becomes a work-in-process. To minimize such a work-in-process and reduce waste in time and resources (people and machines), the system may determine not to select order #2 and not combine order #2 with order #1 and order #4, even though there is a substantial overlap in areas where items from these orders are located. Instead, the system chooses to wait until a new order, say, order #72 that arrives minutes or even hours later and that is synergistic with order #2, is received at a later time. When that happens, the system can combine order #2 and order #72 and direct work recourses to fulfill both orders. Although the above examples describe cases in which a batch is formed with only a few orders, embodiments may be even more efficient with larger batches. In some embodiments, a batch may comprise 50 or more orders, the number being a factor of the availability of space for consolidating the orders, the average size of an item, the skill or experience of a worker, or some other factor.

To ensure orders are grouped into optimal pack groups, in some embodiments, the system may analyze each item in an order to identify a product ID, determine a shelf, room, or other subarea corresponding to the product ID, and determine a virtual order footprint for the order. In some embodiments, the system may analyze each order to identify the product ID and may further compare the product ID with a listing or database of product IDs associated with the various subareas in a total physical storage area to determine a virtual order footprint. As orders may have items in multiple subareas, the creation of pack groups affords the opportunity for the system to select orders for a pack group that contains all items from the same subareas.

Those skilled in the art will appreciate that pack groups in this disclosure may refer to groups of orders that have “synergistic” pick requirements. In some operations, a pack group may have anywhere from 18 to 36 individual orders whose items are picked together. In some embodiments, pack groups are created on demand in real-time triggered by availability of processing resources (picker availability). In one embodiment, pack groups are not created until a batch is activated, which allows new orders to be considered when creating pack groups in order to maximize efficiency.

In some embodiments, to further aid in efficiently fulfilling orders, pack groups may be categorized into the following types: no consolidate orders and consolidate orders. No consolidate orders (ship alone) may include, but are not limited to:
1) Vault Orders (ship alone)
2) Refrigerated Orders (ship alone)
3) Special Bulk Processing Orders (ship alone)
4) Cage Orders only (ship alone)
5) Other Orders (ship alone)

Consolidate Orders may include, but are not limited to:
1) Flow Pick only Orders
2) Bulk Pick only Orders
3) Shelf Pick only Orders
4) Consolidated Flow and Bulk Orders
5) Consolidated Flow and Shelf Orders
6) Consolidated Flow, Bulk and Shelf Orders

In some embodiments, an additional factor in creating optimal pack groups may be directed to making the pack groups have similar processing work effort. This may be done by defining virtual order footprints having equal numbers of product IDs or by selecting orders whenever possible to equalize the number of total items in the pack group. When it is not possible to create an optimal pack group and the hold time limits have been met, embodiments may create less than optimal pack groups. The number of virtual order footprints may vary from batch to batch. That is, more or fewer virtual order footprints may be assigned the next time a batch is activated.

To this end, embodiments of a system may direct available work resources as appropriate. This aspect can be illustrated with reference to FIG. 6 which depicts a diagrammatic representation of an example system architecture in which embodiments disclosed herein may be implemented. In the example of FIG. 6, system 600 may run on one or more server computers 650 communicatively connected to disparate sources (e.g., 10A-10C shown in FIG. 1). Orders received from such disparate sources may be placed in an information pool stored on server computer(s) 650 and/or database 655 via local area network (LAN) 605. System 600 may be communicatively connected to radio frequency (RF) units 677 via RF network 670. RF units 677 can be representative of any suitable wireless means and RF network 670 can be representative of any suitable wireless network. System 600 may also be communicatively connected to various devices such as reporting system 610, and printers 660 via LAN 605, virtual private network (VPN) access point 640, and/or wireless network 670. System 600 may further comprise a tote transportation system having totes 620A . . . 620N and sorting/staging stations 630A . . . 630N. In some embodiments, system 600 may track orders being worked on using identifiers that uniquely identify totes 620A . . . 620N and/or sorting/staging stations 630A . . . 630N.

In some embodiments, as work becomes available (e.g., when a configurable limit is reached and a new batch is created), system 600 may communicate same by, for example, using “call” lights visible from throughout the work floor. In some embodiments, system 600 may create a new batch when a work resource becomes available.

In cases of workers as available resources, people may be available to pick items, sort items into orders, pack orders, and ship orders at various times during the day. For example, a pick worker may make him or herself “available” to system 600 by logging onto RF unit 677. System 600 may create a batch and assign the newly available pick worker to gather items for a set of orders in the batch. To do so, the pick worker may get tote 620A and scan the license or bar code on tote 620A to notify system 600 that tote 620A is used for picking items for the batch. Whether one or more totes are used is configurable globally and may be limited by worker authorization. For example, picking to two totes may have the benefit of higher pick density (more efficient picking), whereas picking to only one tote may be desirable for new or less proficient workers.

In various situations, a worker may be directed to travel to one or more subareas associated with a virtual order footprint to pick items for orders in the virtual order footprint. As the tote either fills to capacity or all the items in a subarea have been picked, the tote(s) may be released to a consolidation area and the worker may be instructed to get another tote or automatically assigned to a different subarea depending upon work.

System 600 may communicate with the worker in various ways. For example, in assigning the worker to pick items for a batch, system 600 may generate a paper printout, send a message to the worker's RF unit for display, and/or make an announcement over an audio means such as a push-to-talk telephone, walkie-talkie, headset, paging system, etc. An advantage of using a paper printout may be that it may be very easy for two workers to use the same checklist, such as if another worker is sent to help or to be trained. Further, as the worker proceeds through the physical storage area picking the items, the worker can line through the items he/she has picked. An advantage of using non-paper based communications means may be the ability for system 600 to constantly update the location and status of the worker. For example, if the worker is using RF unit 677 or some form of an RFID device that can scan or otherwise read a code on an item, the worker can scan each item into system 600 when that item is physically added into a tote. System 600 may then know where the worker is, how long it is taking the worker to pick all the items for each batch, etc. From this information, system 600 may determine how efficient the worker is at fulfilling batches, whether the placement of items should be modified, whether more resources need to be assigned to complete orders by a deadline, etc. System 600 may then update and assign additional resources or otherwise modify a batch.

Embodiments provide a method in which work can be organized through an order prioritization and order selection process to allow the efficient and scalable gathering of order items and the inexpensive and scalable consolidation of order items for packing.

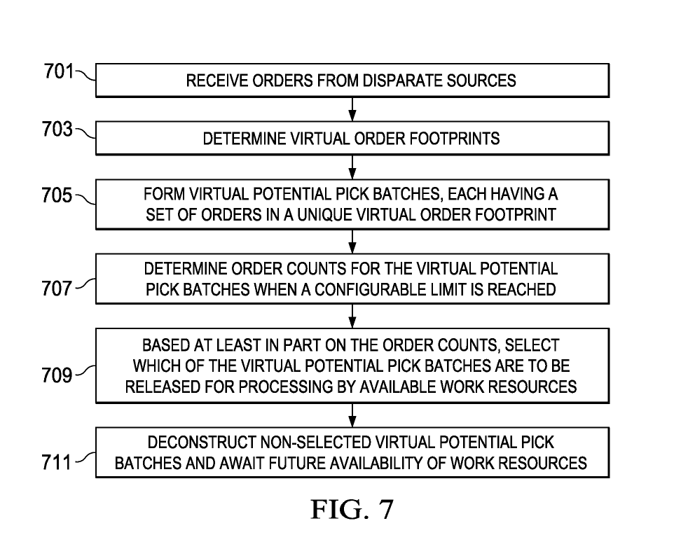

Referring to FIG. 7, in some embodiments, a system (e.g., system 600 shown in FIG. 6) may be configured to implement a method comprising receiving orders from disparate sources communicatively connected to the system over a network (step 701). Each order may specify at least one item located in a physical storage area that has been divided into two or more storage subareas. In some embodiments, the orders may be prioritized in a processing sequence. In some embodiments, work resources necessary to process the orders may become available from time to time.

In some embodiments, the method may further comprise, for each order of the orders received, beginning with high priority orders specifying at least two items and within a configurable limit, determining a virtual order footprint that represents all of the storage subareas corresponding to the items in the order (step 703) and forming a plurality of virtual potential pick batches (step 705). Each virtual potential pick batch may include a set of orders in a unique virtual order footprint.

In some embodiments, the method may further comprise determining an order count for each virtual potential pick batch when the configurable limit is reached (step 707). Based at least in part on the order counts thus determined, the method may proceed to selecting which of the plurality of virtual potential pick batches are to be released for processing by the work resources that have become available (step 709) and deconstructing all the non-selected virtual potential pick batches (step 711) so that new virtual potential pick batch(es) can be constructed depending upon the future availability of work resources.

Those skilled in the art will appreciate that the method described above can be implemented in various ways. As a specific example, a system may select an order from an information pool for analyzing. The system may first determine whether there is more than one item in that order. If not, that single item can be added to a first pack group corresponding to a subarea. If there are multiple items in the order, then the system may determine whether the items correspond to more than one virtual order footprint. If not, then the order can be grouped with other orders that have items only in the same single virtual order footprint. For example, if an order requires only items from a first subarea, that order may be put into the first pack group with other orders that only contain items from that same subarea to ensure the highest pick density for the pack group. In this case, items from an order that has multiple items with the items corresponding to multiple subareas would not be placed in the first pack group. Instead, to the extent possible, all orders that have multiple items that correspond to multiple subareas would be grouped with all other orders that also have items corresponding to the same subareas, and all orders that have item(s) that correspond to the same virtual order footprint will be grouped together. An advantage to this strategy is that the pack group having only orders that correspond to a single virtual order footprint may be easily picked, packed and shipped without needing to go through a consolidation area, thereby significantly increasing the efficiency of the order fulfillment.

If an order contains items corresponding to more than one subarea, the system may include the order in a pack group with other order(s) that also specify items in those subareas. Thus, if one order contains items from the first subarea and a second subarea, grouping that order up in a pack group with only other orders that all contain items from the same subareas ideally will maximize the efficiency of the pack group. For example, if there are 50 sorting stations and there are 50 orders each having items corresponding to two subareas, each sorting station will only depend on two pack groups (i.e., one pack group for each subarea). This reduces the likelihood of having a work-in-progress and increases the efficiency of the order fulfillment.

Once all orders in a batch have been analyzed to create the various pack groups, the system may determine and assign resources to the pack groups to fulfill the batch. Picked items may then be sorted according to their respective orders, packed, and shipped.

As mentioned above, some orders may be designated as priority orders. Accordingly, in some embodiments, the may determine if the order meets criteria for priority handling. If not, the order may be added to the information pool for eventual activation into a batch as described above. If the order is deemed to be a priority order, the system may determine if the items in the priority order correspond to one or more existing pack groups. If not, the priority order may be assigned to an available resource for picking. If the items do correspond to existing pack groups, the system may update the pack group(s) to include the new items from the priority order and all the items for the pack group(s) may be assigned resources for picking. The picked items may then be packed and shipped to fulfill the priority order.

Embodiments may take advantage of characteristics of direct-to-consumer operations including, but not limited to, a constant addition of newly arriving orders to existing batches, dynamic relative prioritization of all orders awaiting processing, maintenance of an information pool (not processing orders until necessary or when an efficient batch can be created), division of physical storage into multiple virtual order footprints, assimilation of orders by the areas in which items are stored, picking items from the physical storage area using an order batch, and in the creation of a batch, usage of business defined rules that include: orders with units within the same areas, order shipment departure time, and availability of resources.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments of the invention described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A system, comprising:
at least one processor: and
at least one non-transitory computer-readable medium storing instructions translatable by the at least one processor to:
receive orders from disparate sources communicatively connected to the system over a network, each order of the orders specifying at least one item located in a physical storage area that has been divided into two or more storage subareas, wherein the orders are prioritized in a processing sequence, wherein work resources necessary to process the orders become available from time to time;
for each order of the orders, beginning with high priority orders specifying at least two items and within a configurable limit, determine a virtual order footprint that represents all of the storage subareas corresponding to the items in the order and form a plurality of virtual potential pick batches, each virtual potential pick batch of the plurality of virtual potential pick batches comprising a set of orders in a unique virtual order footprint;
when the configurable limit is reached, determine an order count for each virtual potential pick batch of the plurality of virtual potential pick batches;
based at least in part on order counts in the plurality of virtual potential pick batches, select which of the plurality of virtual potential pick batches are to be released for processing by the work resources that have become available; and
deconstruct all non-selected virtual potential pick batches of the plurality of virtual potential pick batches.

2. The system of claim 1, wherein the configurable limit is defined with respect to time, a number of orders, or a combination thereof.

3. The system of claim 2, wherein the configurable limit is configured to override the processing sequence in which the orders are prioritized.

4. The system of claim 1, wherein the instructions are further translatable by the at least one processor to determine a number of virtual order footprints based on a number of available resources, an average number of items per order, or a combination thereof.

5. The system of claim 1, wherein the instructions are further translatable by the at least one processor to determine a plurality of subareas to represent the physical storage area, wherein the plurality of subareas is determined based on one or more criteria associated with physical items stored in the physical storage area, the one or more criteria including location of physical items, number of physical items, sensitivity of physical items, special handling instructions, size, and priority.

6. The system of claim 1, wherein the instructions are further translatable by the at least one processor to communicate the selected virtual potential pick batches being released for processing via a printer, an audio means, a wireless means, or a combination thereof.

7. The system of claim 1, wherein the instructions are further translatable by the at least one processor to determine a pick density for each virtual potential pick batch of the plurality of virtual potential pick batches and wherein selection of which of the plurality of virtual potential pick batches are to be released for processing is determined based at least in part on the pick density.

8. A computer program product comprising at least one non-transitory computer readable medium storing program instructions translatable by at least one processor to cause a system to perform:
receiving orders from disparate sources communicatively connected to the system over a network, each order of the orders specifying at least one item located in a physical storage area that has been divided into two or more storage subareas, wherein the orders are prioritized in a processing sequence, wherein work resources necessary to process the orders become available from time to time;
for each order of the orders, beginning with high priority orders specifying at least two items and within a configurable limit, determining a virtual order footprint that represents all of the storage subareas corresponding to the items in the order and forming a plurality of virtual potential pick batches, each virtual potential pick batch of the plurality of virtual potential pick batches comprising a set of orders in a unique virtual order footprint;
when the configurable limit is reached, determining an order count for each virtual potential pick batch of the plurality of virtual potential pick batches;
based at least in part on order counts in the plurality of virtual potential pick batches, selecting which of the plurality of virtual potential pick batches are to be released for processing by the work resources that have become available; and
deconstructing all non-selected virtual potential pick batches of the plurality of virtual potential pick batches.

9. The computer program product of claim 8, wherein the configurable limit is defined with respect to time, a number of orders, or a combination thereof.

10. The computer program product of claim 9, wherein the configurable limit is configured to override the processing sequence in which the orders are prioritized.

11. The computer program product of claim 8, wherein the instructions are further translatable by the at least one processor to determine a number of virtual order footprints based on a number of available resources, an average number of items per order, or a combination thereof.

12. The computer program product of claim 8, wherein the instructions are further translatable by the at least one processor to cause the system to determine a plurality of subareas to represent the physical storage area, wherein the plurality of subareas is determined based on one or more criteria associated with physical items stored in the physical storage area, the one or more criteria including location of physical items, number of physical items, sensitivity of physical items, special handling instructions, size, and priority.

13. The computer program product of claim 8, wherein the instructions are further translatable by the at least one processor to cause the system to communicate the selected virtual potential pick batches being released for processing via a printer, an audio means, a wireless means, or a combination thereof.

14. The computer program product of claim 8, wherein the instructions are further translatable by the at least one processor to cause the system to determine a pick density for each virtual potential pick batch of the plurality of virtual potential pick batches and wherein selection of which of the plurality of virtual potential pick batches are to be released for processing is determined based at least in part on the pick density.

15. A method, comprising:
receiving, by a system embodied on a non-transitory computer readable medium, orders from disparate sources communicatively connected to the system over a network, each order of the orders specifying at least one item located in a physical storage area that has been divided into two or more storage subareas, wherein the orders are prioritized in a processing sequence, wherein work resources necessary to process the orders become available from time to time;
for each order of the orders, beginning with high priority orders specifying at least two items and within a configurable limit, the system determining a virtual order footprint that represents all of the storage subareas corresponding to the items in the order and forming a plurality of virtual potential pick batches, each virtual potential pick batch of the plurality of virtual potential pick batches comprising a set of orders in a unique virtual order footprint;
when the configurable limit is reached, the system determining an order count for each virtual potential pick batch of the plurality of virtual potential pick batches;
based at least in part on order counts in the plurality of virtual potential pick batches, the system selecting which of the plurality of virtual potential pick batches are to be released for processing by the work resources that have become available; and
the system deconstructing all non-selected virtual potential pick batches of the plurality of virtual potential pick batches.

16. The method of claim 15, further comprising:
defining the configurable limit with respect to time, a number of orders, or a combination thereof.

17. The method of claim 16, further comprising:
configuring the configurable limit to override the processing sequence in which the orders are prioritized.

18. The method of claim 15, further comprising:
determining a number of virtual order footprints based on a number of available resources, an average number of items per order, or a combination thereof.

19. The method of claim 15, further comprising:
determining a plurality of subareas to represent the physical storage area, wherein the plurality of subareas is determined based on one or more criteria associated with physical items stored in the physical storage area, the one or more criteria including location of physical items, number of physical items, sensitivity of physical items, special handling instructions, size, and priority.

20. The method of claim 15, further comprising:
communicating the selected virtual potential pick batches being released for processing via a printer, an audio means, a wireless means, or a combination thereof.
